(19) United States
(12) Patent Application Publication
(10) Pub. No.: US 2024/0413658 A1
(43) Pub. Date: Dec. 12, 2024

(54) Programmable Multiple Battery Charging System and Method of Use

(71) Applicant: John Brome, Janesville, WI (US)

(72) Inventor: John Brome, Janesville, WI (US)

(21) Appl. No.: 18/406,270

(22) Filed: Jan. 8, 2024

Related U.S. Application Data
(60) Provisional application No. 63/506,929, filed on Jun. 8, 2023.

(51) Int. Cl. H02J 7/00; H02J 7/02

(52) U.S. Cl. CPC H02J 7/0071; H02J 7/00047; H02J 7/0013; H02J 7/0042; H02J 7/0047; H02J 7/02

(57) ABSTRACT

A programmable battery charging multiplexed system for efficient and safe charging of a plurality of batteries is disclosed. The system comprises a housing with an integrated LCD display and programming pushbuttons, along with multiple cable assemblies for connecting up to eight batteries and works in concert with an external charger. The multiplexer system features a microprocessor with digital I/O pins and non-volatile memory for storing operational parameters and configurations. The system includes a 12V DC power supply cord that converts 110V AC to 12V DC. Relays on the circuit board control the charging sequence, and a terminal strip with overcurrent protection ensures safe connections. The method of operation involves connecting the power supply, batteries, and user provided charger to the multiplexer, engaging a fault detection mode, programming charging and idle times after all faults resolved, and sequentially recharging the batteries.

### CROSS-REFERENCE TO RELATED APPLICATION

The present application claims priority to, and the benefit of, U.S. Provisional Application No. 63/506,929, which was filed on Jun. 8, 2023, and is incorporated herein by reference in its entirety.

### FIELD OF THE INVENTION

The present invention generally relates to the field of charging systems for batteries. More specifically, the present invention relates to a novel charging system for sequentially charging up to eight batteries. The assembly includes a 2×16 character LCD display, a microprocessor, an enclosure, a cable assembly, and a 12V DC power supply. A battery charger or charge controller, used for recharging the batteries, is described in detail below. The assembly can be programmed for different charging times and idle times. Accordingly, the present disclosure makes specific reference thereto. Nonetheless, it is to be appreciated that aspects of the present invention are also equally applicable to other like applications, devices, and methods of manufacture.

### BACKGROUND

By way of background, use of batteries is common in gas-powered vehicles and equipment, such as garden tractors, all-terrain vehicles, recreational vehicles (RVs), recreational watercraft, golf carts, and more. The batteries are essential for starting the engine and powering various electrical components. Such electric batteries often require regular charging to maintain their optimal performance. Batteries for vehicles and equipment that are not used daily, like RVs or golf carts, can drain easily over time.

Individuals owning multiple such vehicles or equipment use individual battery maintainers for each battery. Maintaining multiple battery maintainers can be costly and space consuming. Alternatively, individuals purchase an expensive charger capable of handling multiple batteries simultaneously. Even when using a single charger, there is a requirement to regularly move the charger between different batteries, which can be time-consuming and cumbersome. Manually connecting a battery charger poses risks and can create a spark, which in the presence of flammable gases, could lead to an explosion. There is also the risk of overcharging the battery when batteries are connected to a charger for an extended period. Overcharging can significantly reduce the battery's lifespan and efficiency by causing overheating, electrolyte loss, and plate corrosion. Individuals desire an improved solution for recharging and maintaining a multitude of batteries for electric and/or gas-powered automobiles safely and conveniently.

Therefore, there exists a long-felt need in the art for a multi-battery charging system that can be used for charging a plurality of batteries. Additionally, there is a long-felt need in the art for a multi-battery charging system that obviates the need for purchasing multiple or new chargers. Moreover, there is a long-felt need in the art for an improved battery charging system that removes the process of manually connecting and disconnecting individual or multiple batteries to/from a charger. Further, there is a long-felt need in the art for a charging system that can be programmed to prevent the overcharging of batteries. Furthermore, there is a long-felt need in the art for a multi-battery charging system that prevents charging errors and potential damage to the batteries or the device. Also, there is a long-felt need in the art for a charging system that detects different voltage levels, polarities, and more for safe and easy charging of multiple batteries. Finally, there is a long-felt need in the art for a charging system for charging and maintaining batteries in a wide range of gas-powered vehicles, offering automated and safe charging.

The subject matter disclosed and claimed herein, in one embodiment thereof, comprises a programmable battery charging multiplexed system. The system allows multiple batteries to be charged without the need for multiple battery chargers. The system further comprises a water resistant and sealed housing made of durable materials, including a top wall made of extruded channel and a bottom wall of aluminum channel. The system includes an LCD display for information output, such as faults in connected batteries, voltage level of batteries, and configuration parameters. A pair of programming pushbuttons are disposed for programming charging time and idle time of the batteries to prevent overcharging of the batteries, and integrated LEDs are included for operational feedback. The plurality of batteries are connected to the system using a cable assembly for each cable. Each battery is recharged using a charger which is coupled with the system.

In this manner, the programmable battery charging multiplexed system of the present invention accomplishes all of the foregoing objectives and provides users with a system that allows multiple batteries to be charged without the need for multiple battery chargers and does not require the purchase of a new battery charger, offering use with an existing battery charger or charge controller. A plurality of batteries are connected to the system for charging safely and easily. The system is safe and can be used with different batteries of similar type.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a programmable battery charging multiplexed system. The system allows multiple batteries to be charged without the need for multiple battery chargers. The system further comprises a water resistant and sealed housing made of durable materials, including a top wall made of extruded channel and a bottom wall of aluminum channel. The system includes an LCD display for information output, a pair of programming pushbuttons for programming charging time and idle time of the batteries, and integrated LEDs for operational feedback. A plurality of batteries are connected to the system using a cable assembly for recharging using a charger which is coupled with the system.

In yet another embodiment, a programmable battery charging multiplexed system capable of sequentially charging up to eight batteries is disclosed. The system includes an LCD display for showing programming options, detected faults, and other vital information. The system allows user interaction and programming via two pushbuttons, with one for navigating and adjusting settings and the other for selection and confirmation. The system automatically enters or exits the programming mode based on user interaction or idleness, respectively, and stores settings in an integrated microprocessor.

In another embodiment, a 12V power supply jack is located on the rear surface of the housing to receive a 12V DC power supply cord which converts 110V AC power to 12V DC power. A plurality of extendable and flexible cable assemblies exit from the rear surface of the housing, each cable assembly has an independent and labeled connector at the free end thereof for connecting to a respective battery. A charger connection cable also extends from the rear surface for connecting an external charger to the system.

In yet another embodiment, a battery charging system is disclosed. The system is comprised of a plurality of cable assemblies, each configured to connect the system to a battery. A polarized connector on each cable assembly, is designed to prevent misalignment and reduce the risk of electrical faults, short circuits, or damage to electrical components. A connector pin is included in each polarized connector to couple with a battery connecting wire. A charger is coupled to the system for providing recharging to the batteries.

In yet another embodiment, the sequential multiple battery charging system includes a microprocessor, a plurality of digital I/O pins included in the microprocessor to which a pair of pushbuttons are coupled for configuration and operation of the system. A memory is integrated with the microprocessor, preferably a non-volatile EEPROM with a storage capacity of at least 1024 bytes, and is adapted to store instructions, configuration parameters, and other data for the sequential recharging of multiple batteries. A terminal strip connects cable assemblies for providing charging to batteries connected to the cable assemblies.

In another aspect of the present invention, a method for operating a battery charging system for sequentially charging a plurality of batteries is described. The method includes the steps of connecting up to eight batteries to the system using polarized connectors, initiating a fault detection mode in the system to identify and display any faults in the connected batteries sequentially on an LCD screen, programming the system for charging and idle times using two push buttons, wherein the programming accounts for the voltage capacity of the connected batteries, with default settings of multiple hours (i.e., 3 hours) for charging time and multiple days (i.e., 6 days) for idle time, and connecting a charger to the system for sequentially recharging the connected batteries in a safe and efficient manner.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the programmable battery charging multiplexed system (BCM-Pro) of the present invention in accordance with the disclosed structure;

FIG. 2 illustrates a rear view of the programmable battery charging multiplexed system of the present invention showing connection with external charger in accordance with the disclosed structure;

FIG. 3 illustrates a perspective view showing how up to eight batteries are simultaneously connected to the system for sequential charging in accordance with the disclosed structure;

FIG. 4 illustrates a block diagram showing the internal electronic components of the programmable battery charging multiplexed system of the present invention in accordance with the disclosed structure;

FIG. 5 illustrates a display showing the configuration or programming options in accordance with the disclosed structure;

FIG. 6 illustrates a flow chart depicting a process of working of the multiplexed charging system of the present invention in accordance with the disclosed structure; and

FIG. 7 illustrates each fault condition, the respective fault number and required mitigating action.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a multi-battery charging system that can be used for charging a plurality of batteries. Additionally, there is a long-felt need in the art for a multi-battery charging system that obviates the need for purchasing multiple or new chargers. Moreover, there is a long-felt need in the art for an improved battery charging system that removes the process of manually connecting and disconnecting individual or multiple batteries to/from a charger. Further, there is a long-felt need in the art for a charging system that can be programmed to prevent the overcharging of batteries. Furthermore, there is a long-felt need in the art for a multi-battery charging system that prevents charging errors and potential damage to the batteries or the device. Also, there is a long-felt need in the art for a charging system that detects different voltage levels, polarities, and more for safe and easy charging of multiple batteries by providing a fault name, code number and related output number to prevent battery or equipment damage prior to initiating a charging cycle. Finally, there is a long-felt need in the art for a charging system for charging and maintaining batteries in a wide range of gas-powered vehicles, offering automated and safe charging.

The present invention, in one exemplary embodiment, is a method for operating a battery charging system for sequentially charging a plurality of batteries. The method includes the steps of connecting up to eight batteries to the system using polarized connectors, initiating a fault detection mode in the system to identify and display any faults in the connected batteries sequentially on an LCD screen, programming the system for charging and idle times using two push buttons, wherein the programming accounts for the voltage capacity of the connected batteries, with default settings of multiple hours (i.e., 3 hours) for charging time and multiple days (i.e., 6 days) for idle time, and connecting a charger to the system for sequentially recharging the connected batteries in a safe and efficient manner.

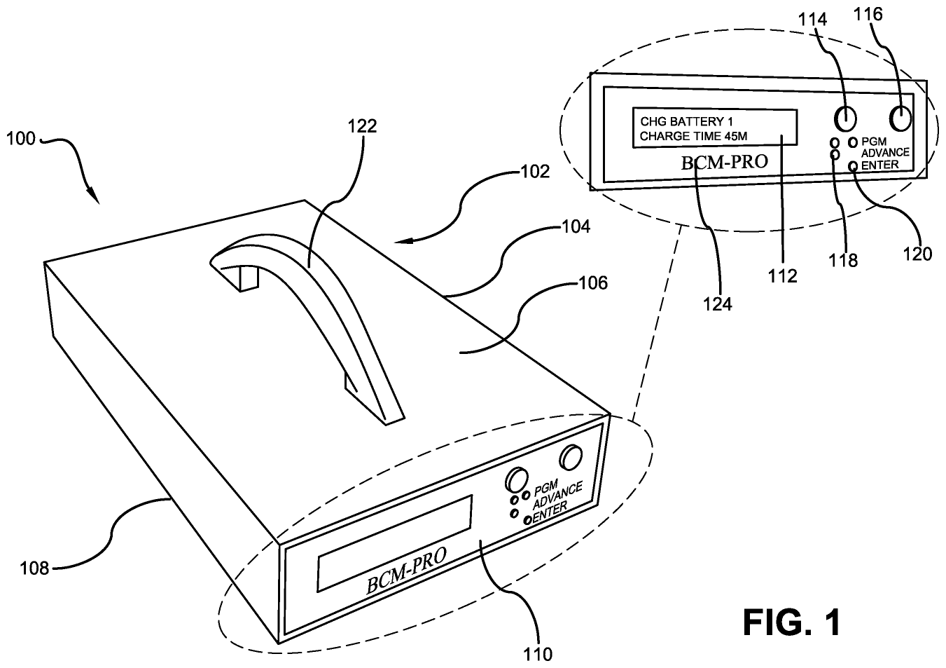

Referring initially to the drawings, FIG. 1 illustrates a perspective view of the programmable battery charging multiplexed system (BCM-Pro) of the present invention in accordance with the disclosed structure. The programmable battery charging multiplexed system 100 is designed to work with an external battery charger for sequentially charging up to eight batteries of a similar type. The multiple battery charging system 100 is portable and reduces the need for multiple charging stations, saving space, and simplifying setup/recharging time by skipping the output channels not connected to batteries during a charge cycle. The system 100 can be used with batteries of different capacities such as 6, 12, 24, or 48-volt, making the system 100 versatile to meet the requirements for different applications. More specifically, the system 100 is in the form of a portable device 102 that has a water resistant and scaled housing 104. The housing 104 has a top wall 106 made of extruded channel and a bottom wall 108 of aluminum channel.

The front surface 110 of the housing 104 has an LCD display 112 for displaying different information, such as detected faults across the connected batteries. As described later in the disclosure, the configuration or programming information is also displayed on the LCD display 112. Preferably, the LCD display 112 is a 2×16 character LCD display but can be any other LCD, LED, OLED, or any other display. A pair of programming pushbuttons including a first pushbutton 114 and a second pushbutton 116 are disposed on the front surface 110. The pushbuttons 114, 116 are used for programming the programmable battery charging multiplexed system 100 to meet requirements of different users. The pushbuttons 114, 116 are connected to the microprocessor for programming the multiple battery charging system 100.

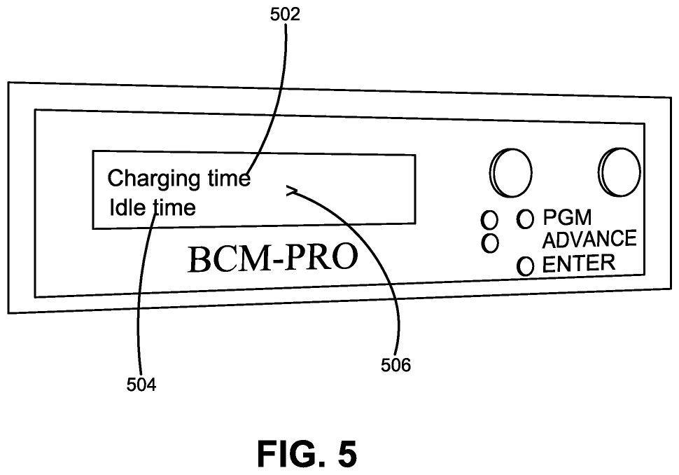

In the preferred embodiment, the first button 114 is adapted for navigating through the programming options and adjusting settings and the second button 116 is adapted for selecting a highlighted option or confirming a setting. Preferably, both the pushbuttons 114, 116 are pressed and held for few seconds such as three to five seconds to enter the system 100 into programming mode. When the system 100 enters the programming mode, a cursor, such as “>” 506 symbol, is displayed on the LCD display 112 as illustrated in FIG. 5.

In the preferred embodiment, the system 100 provides a charging time programming and an idle time programming as illustrated in FIG. 5. The charging time 502 refers to the charging duration for which each battery connected to the system 100 is charged and the idle time 504 refers to the interval between the charging of consecutive batteries. The programming modes are displayed on the LCD display 112. Once, the system 100 enters the programming mode, the first button 114 is used for selecting a programming mode and for adjusting a value of the selected programming mode. For example, when charging time is selected, the left pushbutton is pressed and held to increase the value (e.g., increase charging time from one hour to two hours). Also, when the maximum value is reached, such as eight hours, further pressing may loop back to the minimum value, such as one hour. The second button 116 is pressed to confirm and set the value selected using the first button 114.

In some embodiments, the buttons 114, 116 are pushed again simultaneously for exiting the programming mode or alternatively, the multiple battery charging system 100 may exit the programming mode after being idle for some time, such as one minute. It will be apparent to a person skilled in the art that the microprocessor coupled to the pushbuttons 114, 116 stores the programmed settings of the system 100. In the present embodiment, the pushbuttons 114, 116 are single-pole, single-throw (SPST) buttons but can any other pushbuttons as per preferences of the users.

The first set 118 of LEDs illuminate when the first button 114 is pressed and held, and the second set 120 of LEDs illuminate when the second button 118 is pressed and held. For easy handling and transportation of the system 100, a handle 122 is integrated to the top wall 106 of the housing 104. A logo or indicia 124 can be disposed on the front surface 110 for branding and marketing purposes.

The housing 104 is sealed and can be opened using mechanical tools to access included circuitry and components. The top and bottom walls are designed to be mechanically connected using fasteners, such as screws and bolts.

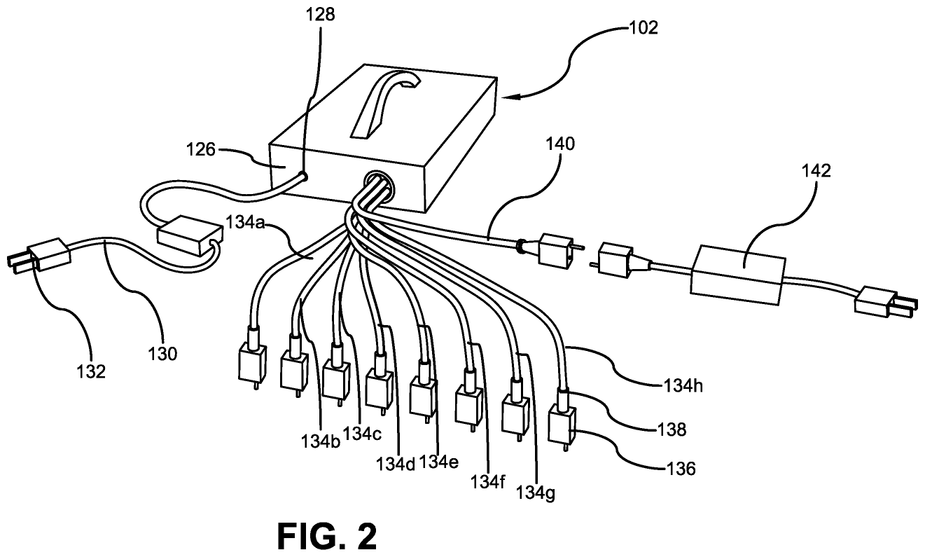

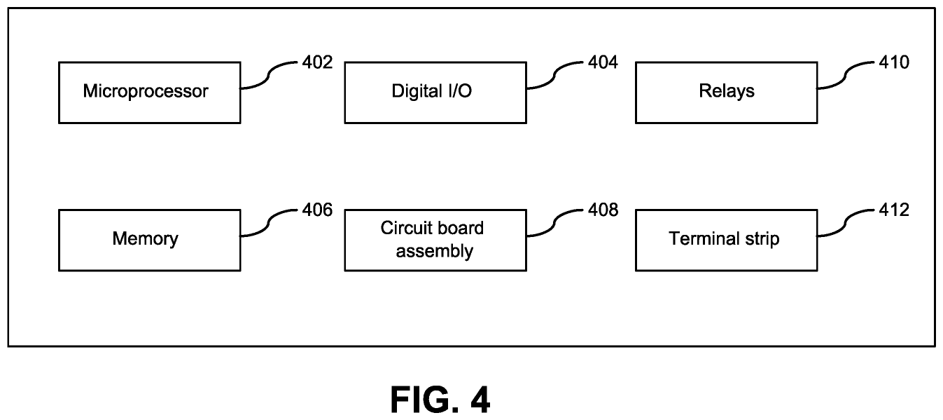

FIG. 2 illustrates a rear view of the programmable battery charging multiplexed system of the present invention showing connection with an external charger in accordance with the disclosed structure. The rear surface 126 of the housing 104 includes a 12V power supply jack 128 with a connected 12V DC power supply cord 130. The 12V DC power supply cord 130 is configured to convert 110V AC into 12V DC. The 110V AC connector 132 can be used for coupling with any conventional AC power supply. The 12V DC power supply is used for functionality of the relays in the circuit board (illustrated in FIG. 4).

From the rear surface 126, eight cable assemblies 134a-h extend independently, wherein each cable assembly is used for attaching to a battery to be charged using the multiplexed charging system 100. The cables 134a-h are extendable and flexible, and each cable has an independent connector 136 disposed at the free end 138 of the cable (shown exemplary on the cable 134h). A charger connection cable 140 also extends out from the rear surface 126 for enabling a user to connect a charger 142 to the charging system 100 for recharging the connected batteries. All cables exit out the back of the aluminum channel and are strain relief to protect the cables from wear and tear due to bending or pulling.

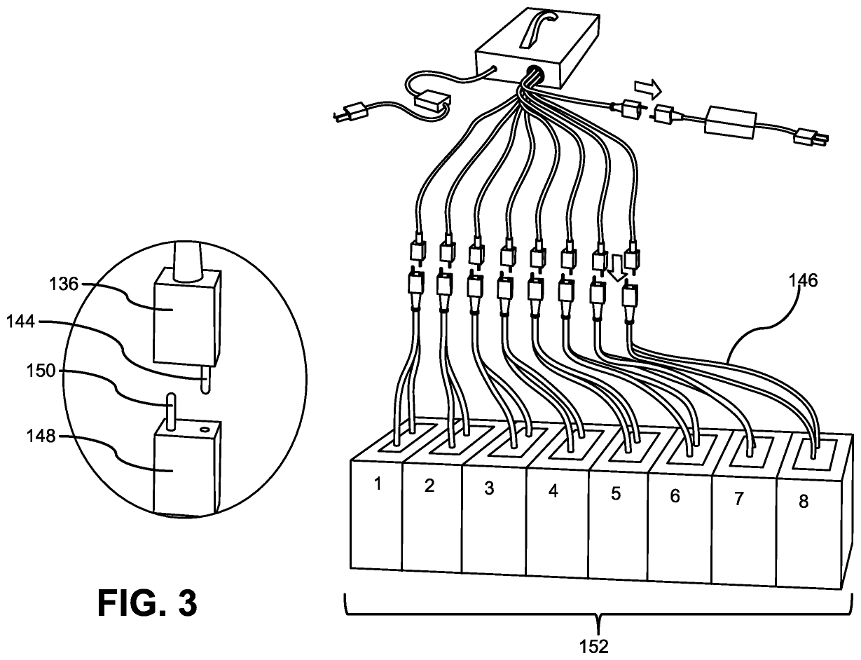

FIG. 3 illustrates a perspective view showing how up to eight batteries are simultaneously connected to the system for sequential charging in accordance with the disclosed structure. As illustrated, the connector 136 of each cable 134a-h is a polarized connector. The advantage of the polarized connector is that the connector 136 prevents misalignment, which could cause electrical faults, short circuits, or damage to the electrical components. The connector 136 includes a connector pin 144, which couples with the battery connecting wire 146, and the battery connecting wire 146 includes another connector pin 150 in the connector 148 which couples with the polarized connector 136.

Each battery 152 is coupled to one of the cable assemblies 134a-h by coupling the connectors 136, 148 for establishing an electrical connection between the system 100 and the batteries 152. The charger 142 is also coupled in the similar manner to the system 100. It will be appreciated to a person skilled in the art that up to eight conventional batteries can be added to the system 100 using the cable assemblies 134a-h. A single charger 142 can be used for sequentially charging up to eight batteries, thereby saving space and money by eliminating purchase of multiple chargers for charging batteries.

FIG. 4 illustrates a block diagram showing the internal electronic components of the programmable battery charging multiplexed system of the present invention in accordance with the disclosed structure. The system 100 includes a microprocessor 402 for controlling operation of the system 100. Preferably, the microprocessor 402 is an ATMega328P microprocessor but can be any microprocessor used in general purpose computers and other devices. The microprocessor 402 includes digital I/O pins 404 to which the pushbuttons 114, 116 are coupled for configuration of the system 100. The microprocessor 402 includes a memory 406 which is preferably a non-volatile memory EEPROM and has a storage capacity of at least 1024 bytes. The memory 406 is adapted to store different instruction, configuration parameters, and more for working of the system 100 to recharge multiple batteries sequentially.

A circuit board assembly 408 is included in the system 100 and is used for providing electrical pathways for connecting different electronic components. Relays 410 are disposed on the circuit board 408 for controlling the charging sequence of the batteries. A terminal strip 412 is also included for connecting the cable assemblies to which the cable assemblies are individually fused with terminals, such as ring-tongue terminals. The terminal strip 412 also includes overcurrent protection, such as fuses for each battery connection.

It should be noted that all electronic components, such as microprocessor 402 and memory 406, are also mounted on the circuit board 408 for reliability, efficiency, and longevity of the BCM-Pro system 100. Additional components such as DC/DC converters may also be included in the system 100.

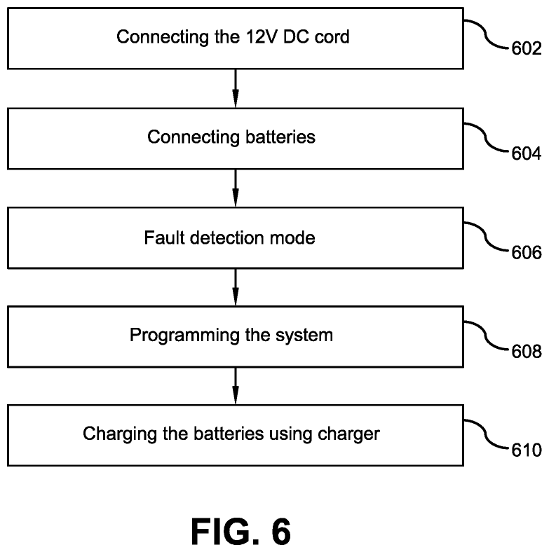

FIG. 6 illustrates a flow chart depicting a process of working of the multiplexed charging system of the present invention in accordance with the disclosed structure. Initially, the 12V DC power supply cord 130 is connected to the jack 128 and a 110V AC power supply (Step 602). Then, up to eight batteries are connected to the cable assemblies as illustrated in FIG. 3 using the polarized connector 136 (Step 604). Thereafter, BCM-Pro system enters a fault detection mode to check for any faults in the connected batteries and display the faults sequentially on the LCD screen (Step 606).

In the next step, programming is performed for charging time and idle time using the two push buttons (Step 608). Programming can be based on the voltage capacity of the connected batteries. Preferably, the default charging time is a plurality of hours (i.e., three hours) and the default idle item is a plurality of days (i.e., six days). Then, in step 610, the charger is connected to the system 100 for recharging the batteries sequentially in an easy and safe manner (Step 610).

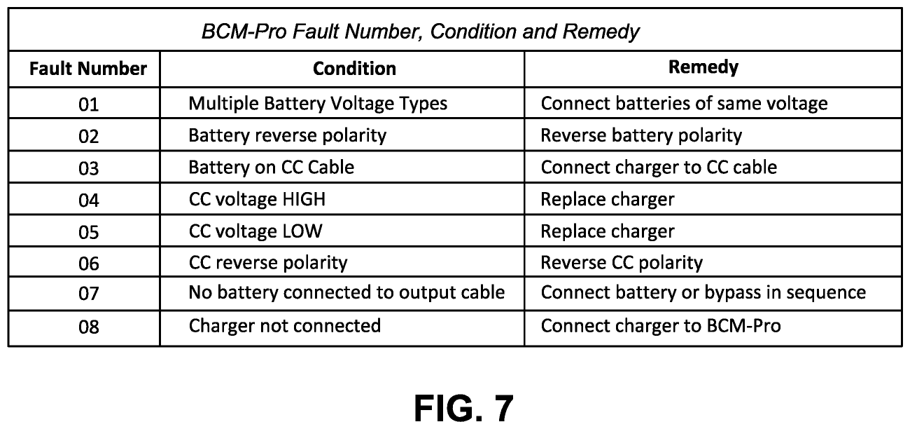

As shown in FIG. 7, each fault condition, along with a respective fault number, and a mitigating remedy or action is illustrated. For example, fault number 01 displays a condition of ‘multiple battery voltage types’ and the associated remedy of ‘connect batteries of same voltage’. Fault number 02 displays a condition of ‘battery reverse polarity’ and the associated remedy of ‘reverse battery polarity’. Additional fault numbers 03 through 08, conditions, and remedies are detailed in FIG. 7.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multiplexed charging system”, “programmable battery charging multiplexed system”, “charging system”, “BCM-Pro system”, and “multiple battery charging system” are interchangeable and refer to the programmable battery charging multiplexed system 100 of the present invention.

Notwithstanding the foregoing, the programmable battery charging multiplexed system 100 of the present invention can be of any suitable size and configuration as is known in the art without affecting the overall concept of the invention, provided that it accomplishes the above-stated objectives. One of ordinary skill in the art will appreciate that the programmable battery charging multiplexed system 100 as shown in the FIGS. are for illustrative purposes only, and that many other sizes and shapes of the programmable battery charging multiplexed system 100 are well within the scope of the present disclosure. Although the dimensions of the programmable battery charging multiplexed system 100 are important design parameters for user convenience, the programmable battery charging multiplexed system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A programmable battery charging system for sequentially charging multiple batteries, the programmable battery charging system comprising:
a portable battery charging system having a housing and a plurality of charging stations for charging a plurality of batteries of different capacities, wherein said portable battery system having a front surface including an LCD display for displaying information and actuation buttons including a microprocessor for programming said battery charging system;
wherein said housing is water resistant and sealed;
wherein said actuation buttons having at least a first button for navigating a plurality of programming options and a second button for selecting a highlighted option;
wherein said plurality of programming options having at least a charging time programming and an idle time programming;
wherein said charging time programming programs a charging duration for a selected battery connected to said battery charging system; and
further wherein said idle time programming programs an idle interval between a first battery charging and at least a second battery charging.

2. The programmable battery charging system of claim 1, wherein said charging duration is a selected number of hours and said first button increments said charging duration by one hour for each actuation of said first button.

3. The programmable battery charging system of claim 2, wherein said charging duration is confirmed by actuation of said second button.

4. The programmable battery charging system of claim 3, wherein said different capacities selected from the group consisting of a 6 volt battery, a 12 volt battery, a 24 volt battery, and a 48-volt battery.

5. The programmable battery charger system of claim 4 further comprising a 12V power supply jack including a connected 12V DC power supply cord.

6. The programmable battery charger system of claim 5, wherein said 12V DC power supply cord converts a coupled 110V AC into 12V DC.

7. The programmable battery charger system of claim 6, wherein each one of said plurality of charging stations having a cable assembly for attaching to a battery.

8. The programmable battery charger system of claim 7, wherein said cable assembly is extendable and flexible including an independent connector at a free end of said cable assembly.

9. The programmable battery charger system of claim 8, wherein said plurality of charging stations is eight charging stations.

10. The programmable battery charger system of claim 9 further comprising a charger connection cable for connecting a charger to said battery charging system for supplying power to said plurality of charging stations.

11. The programmable battery charger system of claim 10, wherein said first button and said second button are single pole single throw (SPST) buttons.

12. The programmable battery charger system of claim 11, wherein said independent connector is a polarized connector.

13. The programmable battery charger system of claim 12, wherein said microprocessor having a non-volatile memory EEPROM including a storage capacity of at least 1024 bytes.

14. The programmable battery charger system of claim 13 further comprising a circuit board assembly having a plurality of electrical pathways for connecting said plurality of batteries including a plurality of relays disposed on said circuit board for controlling a charging sequence of said first battery charging to said at least a second battery charging.

15. A programmable battery charging system for sequentially charging multiple batteries, the programmable battery charging system comprising:
a portable battery charging system having a housing and a plurality of charging stations for charging a plurality of batteries of different capacities, wherein said portable battery system having a front surface including an LCD display for displaying information and actuation buttons including a microprocessor for programming said battery charging system;
wherein said actuation buttons having at least a first button for navigating a plurality of programming options and a second button for selecting a highlighted option;
wherein said plurality of programming options having at least a charging time programming and an idle time programming;
wherein said charging time programming programs a charging duration for a selected battery connected to said battery charging system;
wherein said idle time programming programs an idle interval between a first battery charging and at least a second battery charging; and
a circuit board assembly having a plurality of electrical pathways for connecting said plurality of batteries including a plurality of relays disposed on said circuit board for controlling a charging sequence of said first battery charging to said at least a second battery charging.

16. The programmable battery charger system of claim 15, wherein said housing is water resistant and sealed including a top wall of extruded channel and a bottom wall of aluminum channel.

17. A method of programming battery charging for sequentially charging multiple batteries, the method comprising the steps of:
providing a portable battery charging system having a housing and a plurality of charging stations for charging a plurality of batteries of different capacities, wherein said portable battery system having a front surface including an LCD display for displaying information and actuation buttons including a microprocessor for programming said battery charging system, further wherein said actuation buttons having at least a first button for navigating a plurality of programming options and a second button for selecting a highlighted option; and
programming at least a charging time and an idle time with said plurality of programming options, wherein said charging time is a charging duration for a selected battery connected to said battery charging system and said idle time is an idle interval between a first battery charging and at least a second battery charging.

18. The method of programming battery charging of claim 17, wherein said charging duration is a selected number of hours and said first button increments said charging duration by one hour for each actuation of said first button.

19. The method of programming battery charging of claim 18, wherein said charging duration is confirmed by actuation of said second button.

20. The method of programming battery charging of claim 19, wherein said portable battery charging system having a circuit board assembly including a plurality of electrical pathways for connecting said plurality of batteries including a plurality of relays disposed on said circuit board for controlling a charging sequence of said first battery charging to said at least a second battery charging.
